(19) United States
(12) Patent Application Publication
(10) Pub. No.: US 2013/0113315 A1
(43) Pub. Date: May 9, 2013

(54) BEARING ASSEMBLY AND MOTOR INCLUDING THE SAME

(71) Applicant: Han Byul KIM, Seoul (KR)

(72) Inventor: Han Byul KIM, Seoul (KR)

(73) Assignee: Samsung Electro-Mechanics Co., Ltd., Suwon (KR)

(21) Appl. No.: 13/357,035

(22) Filed: Jan. 24, 2012

(30) Foreign Application Priority Data
Nov. 3, 2011 (KR) 10-2011-0113681

(51) Int. Cl. F16C 32/06; H02K 7/08

(52) U.S. Cl. 310/90; 384/100

(57) ABSTRACT

There is provided a bearing assembly including: a sleeve supporting a shaft; a base cover coupled to the sleeve by press-fitting and closing a lower portion of the sleeve; and at least one deformation prevention part formed to be depressed from an outer peripheral surface of the base cover in an inner diameter direction and preventing deformation of the base cover when the base cover is press-fitted into the sleeve.

### CROSS-REFERENCE TO RELATED APPLICATIONS

This application claims the priority of Korean Patent Application No. 10-2011-0113681 filed on Nov. 3, 2011, in the Korean Intellectual Property Office, the disclosure of which is incorporated herein by reference.

### BACKGROUND OF THE INVENTION

1. Field of the Invention

The present invention relates to a bearing assembly and a motor including the same, and more particularly, to a motor capable of being used in a hard disk drive (HDD) rotating a recording disk.

2. Description of the Related Art

A hard disk drive (HDD), an information storage device, reads data stored on a disk or writes data to the disk using a read/write head.

The hard disk drive requires a disk driving device capable of driving the disk. In the disk driving device, a small-sized spindle motor is used.

In the small-sized spindle motor, a fluid dynamic pressure bearing has commonly been used. The fluid dynamic pressure bearing means a bearing in which a shaft, a rotating member of the fluid dynamic pressure bearing assembly, and a sleeve, a fixed member thereof, include oil interposed therebetween, such that rotation of the shaft is supported by fluid pressure generated in the oil.

Therefore, a spindle motor using the fluid dynamic pressure bearing as described above necessarily requires oil, and the oil may be blocked from being leaked to the outside by a base cover coupled to the sleeve.

A base cover provided in a spindle motor according to the related art is coupled to the sleeve by bonding. However, due to the characteristics of this bonding, foreign objects from a bond have often been generated in the spindle motor according to the related art.

These foreign objects from the bond may cause defects such as the non-rotation of a rotating member or may move along oil in the spindle motor to thereby hinder the rotation of the rotating member.

Therefore, research into a technology for significantly increasing the performance and lifespan of a spindle motor by suppressing the generation of foreign objects from a bond, at the time of coupling a base cover and a sleeve in the spindle motor, is urgently required.

### SUMMARY OF THE INVENTION

An aspect of the present invention provides a bearing assembly capable of effectively sealing oil by improving coupling force between a base cover and a sleeve, simultaneously with preventing non-rotation of a rotating member due to foreign materials, at the time of coupling the base cover and the sleeve, and a motor including the same.

According to an aspect of the present invention, there is provided a bearing assembly including: a sleeve supporting a shaft; a base cover coupled to the sleeve by press-fitting and closing a lower portion of the sleeve; and at least one deformation prevention part formed to be depressed from an outer peripheral surface of the base cover in an inner diameter direction and preventing deformation of the base cover when the base cover is press-fitted into the sleeve.

The sleeve may include a protrusion part formed by protruding an edge of the lower portion thereof in an axial direction, and the protrusion part may have an inner peripheral surface coupled to the outer peripheral surface of the base cover.

The sleeve may include a protrusion part formed by protruding an edge of the lower portion thereof in an axial direction, and the protrusion part and the deformation prevention part may include a deformation preventing space formed therebetween, the deformation preventing space preventing the deformation of the base cover.

The base cover may have an outer diameter larger than a diameter of an inner peripheral surface of the sleeve corresponding to the outer peripheral surface of the base cover.

The deformation prevention part may allow upper and lower surfaces of the base cover to be in communication with each other.

The deformation prevention part maybe depressed in the inner diameter direction within a range in which a leakage of oil filling an upper portion of the base cover to the outside is blocked.

The at least one deformation prevention part may includes a plurality of deformation prevention parts, the plurality of deformation prevention parts being symmetrical with regard to each other based on a center of the shaft.

According to another aspect of the present invention, there is provided a motor including: the bearing assembly of any one of claims 1 to 7; a hub rotating together with the shaft and including a magnet coupled thereto; and a base including the sleeve and a core coupled thereto, the core having a coil wound therearound generating rotational driving force.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor including a bearing assembly according to an embodiment of the present invention;

FIG. 2 is a schematic cut-away exploded perspective view showing the bearing assembly according to the embodiment of the present invention;

FIG. 3 is a schematic exploded cross sectional view showing a coupling process of a base cover in the bearing assembly according to the embodiment of the present invention;

FIGS. 4A and 4B are a schematic cut-away perspective view and a schematic plan view showing the base cover provided in the bearing assembly according to the embodiment of the present invention;

FIGS. 5A and 5B are a schematic cut-away perspective view and a schematic plan view showing a first modified example of a base cover provided in the bearing assembly according to the embodiment of the present invention;

FIGS. 6A and 6B are a schematic cut-away perspective view and a schematic plan view showing a second modified example of a base cover provided in the bearing assembly according to the embodiment of the present invention;

FIG. 7 is a schematic cut-away perspective view showing a third modified example of a base cover provided in the bearing assembly according to the embodiment of the present invention; and

FIG. 8 is a schematic cut-away perspective view showing a fourth modified example of a base cover provided in the bearing assembly according to the embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings, within the scope of the present invention.

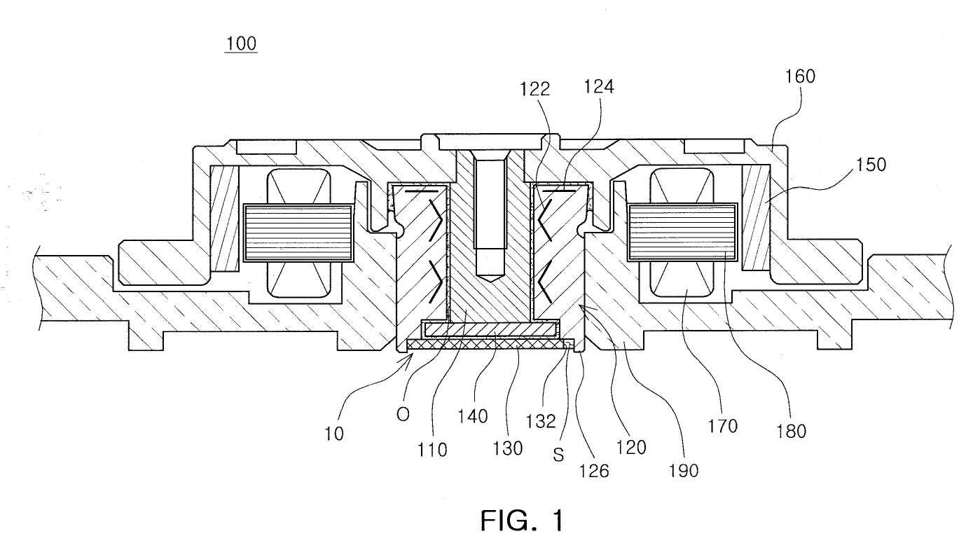

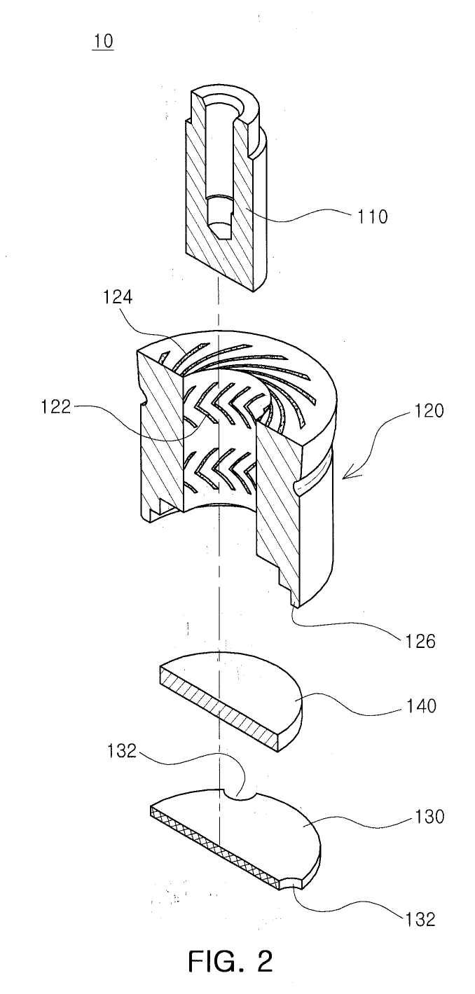

FIG. 1 is a schematic cross-sectional view showing a spindle motor including a bearing assembly according to an embodiment of the present invention. FIG. 2 is a schematic cut-away exploded perspective view showing the bearing assembly according to the embodiment of the present invention.

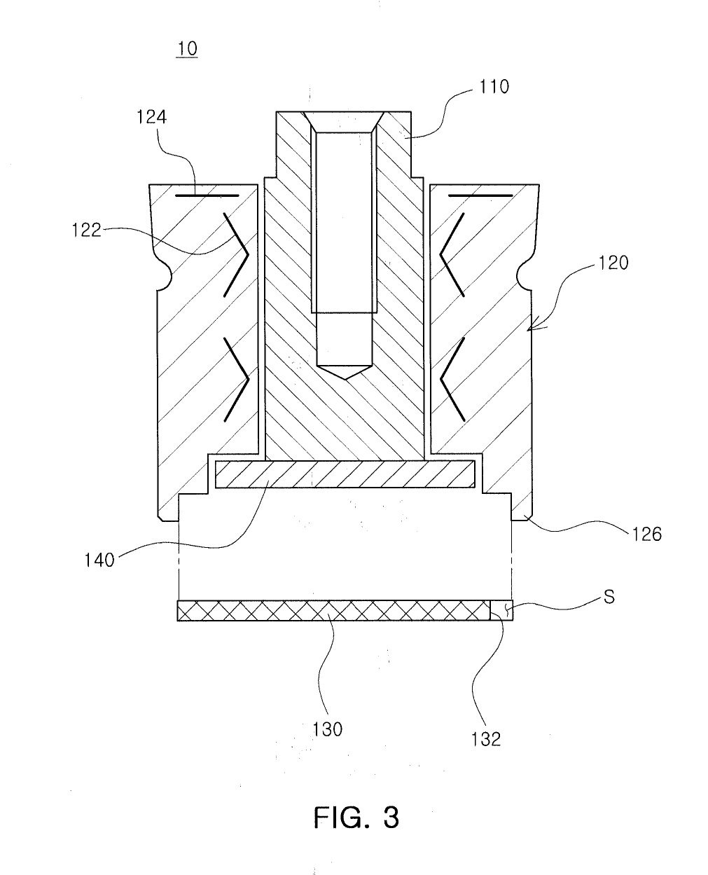

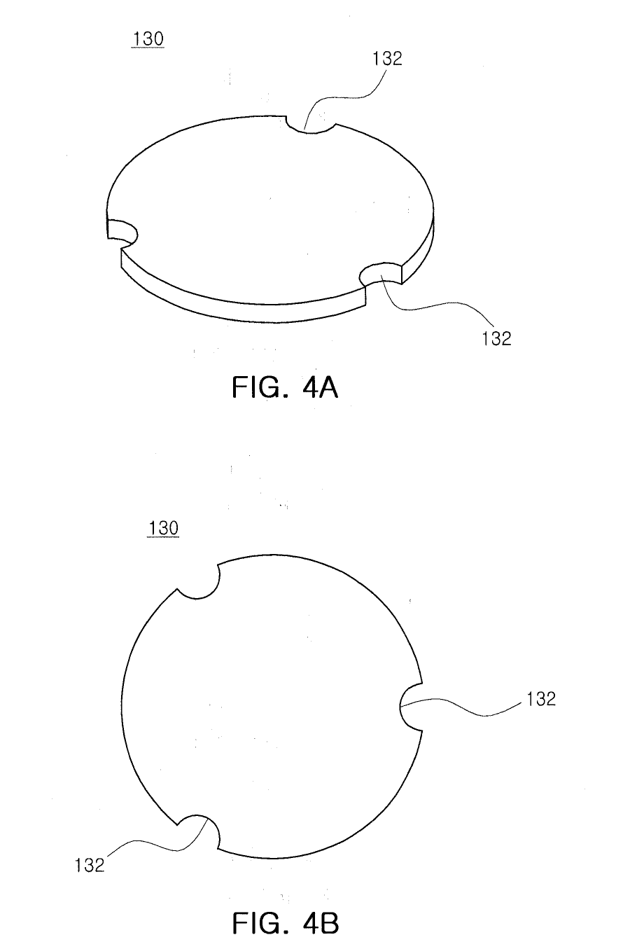

FIG. 3 is a schematic exploded cross sectional view showing a coupling process of a base cover in the bearing assembly according to the embodiment of the present invention. FIGS. 4A and 4B are a schematic cut-away perspective view and a schematic plan view showing the base cover provided in the bearing assembly according to the embodiment of the present invention.

Referring to FIGS. 1 through 4B, a motor 100 including a bearing assembly according to the embodiment of the present invention may include a bearing assembly 10 including a sleeve 120 and a base cover 130, a hub 160 having a magnet 150 coupled thereto, and a base 190 including a core 180 having a coil 170 wound therearound.

Terms with respect to directions will be first defined. As viewed in FIG. 1, an axial direction refers to a vertical direction based on the shaft 110, and an outer diameter or inner diameter direction refers to a direction towards an outer edge of the hub 160 based on the shaft 110 or a direction towards the center of the shaft 110 based on the outer edge of the hub 160.

In addition, a circumferential direction refers to a direction of rotation of the shaft 110, that is, a direction corresponding to an outer peripheral surface of the shaft 110.

The bearing assembly 10 may include the sleeve 120 supporting the shaft 110 and the base cover 130 closing a lower portion of the sleeve 120.

The sleeve 120 is a component supporting the shaft 110, which is a component of a rotating member. The sleeve 120 may support the shaft 110 such that an upper end of the shaft 110 protrudes upwardly in the axial direction and may be formed by forging Cu or Al or sintering a Cu—Fe based alloy powder or a steel use stainless (SUS) based power.

In addition, the sleeve 120 may include a shaft hole having the shaft 110 inserted thereinto such that the sleeve 120 and the shaft 110 have a micro clearance therebetween, and the micro clearance may be filled with oil O to thereby stably support the shaft 110 by radial dynamic pressure via the oil O.

Here, the radial dynamic pressure via the oil O may be generated by a fluid dynamic pressure part 122 formed in at least one of an inner peripheral surface of the sleeve 120 and the outer peripheral surface of the shaft 110. The fluid dynamic pressure part 122 may have one of a herringbone shape, a spiral shape and a screw shape.

However, the fluid dynamic pressure part 122 is not limited to being formed in the inner peripheral surface of the sleeve 120 but may also be formed in the outer peripheral surface of the shaft 110, as described above. In addition, the number of fluid dynamic pressure parts is also not limited.

In addition, the sleeve 120 may include a thrust dynamic pressure part 124 formed in an upper surface thereof so as to generate thrust dynamic pressure via the oil O. The rotating member including the shaft 110 may rotate in a state in which a predetermined floating force is secured by the thrust dynamic pressure part 124.

Here, the thrust dynamic pressure part 124 may be a groove having a herringbone shape, a spiral shape, or a screw shape, similar to that of the fluid dynamic pressure part 122. However, the thrust dynamic pressure part 124 is not necessarily limited to having the above-mentioned shapes but may have any shape as long as thrust dynamic pressure may be provided thereby.

In addition, the thrust dynamic pressure part 124 is not limited to being formed in the upper surface of the sleeve 120 but may also be formed in one surface of the hub 160 corresponding to the upper surface of the sleeve 120.

Meanwhile, a stopper 140 may be provided under the shaft 110 in order to prevent the shaft 110 from being excessively floated at the time of the rotation thereof.

Here, the stopper 140 may be separately fabricated and then coupled to the shaft 110. However, the stopper 140 may be integrally formed with the shaft 110 at the time of fabricating thereof and may rotate together with the shaft 110 at the time of the rotation of the shaft 110.

In the case in which the rotating member including the shaft 110 is excessively floated, an outer part the stopper 140 may come into contact with a lower surface of the sleeve 120 to thereby prevent the rotating member from being excessively floated.

Further, the sleeve 120 may include the base cover 130 coupled to the lower portion thereof so as to close the lower portion thereof. The motor 100 according to the embodiment of the present invention may be formed to have a full-fill structure by the base cover 130.

Here, the sleeve 120 may include a protrusion part 126 formed by protruding an edge of the lower portion thereof in the axial direction in order to be coupled to the base cover 130, whereby the protrusion part 126 may have an inner peripheral surface coupled to an outer peripheral surface of the base cover 130.

Hereinafter, a method of coupling the sleeve 120 and the base cover 130 will be described.

First, the method of coupling the base cover 130 and the sleeve 120 may be a forced insertion method, that is, a press-fitting method. In order to improve coupling force by the press-fitting, the base cover 130 may have an outer diameter slightly larger than a diameter of the inner peripheral surface of the sleeve 120 corresponding to the outer peripheral surface of the base cover 130.

Therefore, when the base cover 130 is forcedly press-fitted into an internal space of the sleeve 120 by external force, the internal space being provided by the protrusion part 126 of the sleeve 120, the base cover 130 may firmly close the lower portion of the sleeve 120.

In this case, the base cover 130 and the protrusion part 126 of the sleeve 120 may be in contact with each other in a portion of the outer peripheral surface of the base cover 130.

In other words, the base cover 130 may include at least one deformation prevention part 132 preventing the base cover 130 from being deformed in the case in which the base cover 130 is press-fitted into the protrusion part 126 of the sleeve 120.

The deformation prevention part 132 may be formed to be depressed from the outer peripheral surface of the base cover 130 by a predetermined length in the inner diameter.

Therefore, by the deformation prevention part 132, a surface on which the base cover 130 and the protrusion part 126 of the sleeve 120 are in contact with each other when the base cover 130 is press-fitted into the protrusion part 126 of the sleeve 120 may be a portion of the outer peripheral surface of the base cover 130, except for a region in which the deformation prevention part 132 is formed.

In addition, a deformation prevention space S, which is a predetermined space, may be formed between the deformation prevention part 132 and the protrusion part 126 of the sleeve 120 by the deformation prevention part 132.

That is, the deformation prevention part 132 and the deformation prevention space S may reduce stress due to the press-fitting occurring when the base cover 130 is pres-fitted into the protrusion part 126 of the sleeve 120, thereby preventing deformation of the base cover 130.

Here, the prevention of the deformation of the base cover 130 will be described in detail. The sleeve 120 and the base cover 130 provided in the bearing assembly 10 according to the embodiment of the present invention may be coupled to each other by press-fitting method without using an adhesive.

Here, coupling force between the base cover 130 and the sleeve 120 is a factor associated with damage due to external impacts as well as a significantly important factor in preventing the oil 0 filled in a space between the shaft 110 and the sleeve 120 and in an upper portion of the base cover 130 from being leaked to the outside.

That is, in the spindle motor 100, the coupling force between the base cover 130 and the sleeve 120 needs to be significantly increased. As a result, according to the embodiment of the present invention, a press-fitting amount of the base cover 130 needs to be increased.

Therefore, in order to increase the press-fitting amount, the outer peripheral surface of the base cover 130 needs to have a diameter larger than that of the inner peripheral surface of the protrusion part 126 of the sleeve 120.

However, when the above-mentioned method is used in order to increase the press-fitting amount as described above, the base cover 130 may be deformed to be convex downwardly in the axial direction after the base cover 130 is press-fitted into the sleeve 120.

Therefore, the deformation of the base cover 130 after the press-fitting causes the base cover 130 to contact other components of the spindle motor 100, to thereby cause defects.

However, the base cover 130 provided in the bearing assembly 10 according to the embodiment of the present invention includes at least one deformation prevention part 132 formed to be depressed from the outer peripheral surface of the base cover 130 in the inner diameter direction, whereby the stress due to the press-fitting may be reduced.

As a result, since the stress due to the press-fitting maybe significantly reduced by the deformation prevention part 132 and the deformation prevention space S formed by the deformation prevention part 132, the deformation of the base cover 130 after the press-fitting may be prevented.

Meanwhile, the deformation prevention part 132 may allow upper and lower surfaces of the base cover 130 to be in communication with each other, and a radial cross-section of the deformation prevention part 132 formed in the upper surface of the base cover 130 may have an arc shape.

In addition, the deformation prevention part 132 may be depressed in the inner diameter direction within the range in which a leakage of the oil O filled in upper portion of the base cover 130 to the outside is blocked.

Further, the deformation prevention part 132 may be provided in plural and the plurality of deformation prevention parts 132 may be formed in the base cover 130 and be symmetrical with regard to each other based on the center of the shaft 110.

The hub 160 may be a component of the rotating member rotatably provided with respect to a fixed member including the base 190.

In addition, the hub 160 may include an annular ring shaped magnet 150 provided on an inner peripheral surface thereof, the annular ring shaped magnet 150 corresponding to the core 180 while having a predetermined interval therebetween.

Here, the magnet 150 interacts with the coil 170 wound around the core 180, whereby the motor 100 according to the embodiment of the present invention may obtain rotational driving force.

The base 190 may be a component of the fixed member supporting rotation of the rotating member including the shaft 110 and the hub 160 with respect to the rotating member.

Here, the base 190 may include the core 180 coupled thereto, the core 180 having the coil 170 wound therearound. The core 180 may be fixedly disposed on an upper portion of the base 190 including a printed circuit board (not shown) having pattern circuits printed thereon.

In other words, an outer peripheral surface of the sleeve 120 and the core 180 having the coil 170 wound therearound are inserted into the base 190, such that the sleeve 120 and the core 180 may be coupled to the base 190.

Here, as a method of coupling the sleeve 120 and the core 180 to the base 190, a bonding method, a welding method, a press-fitting method, or the like, may be used. However, a method of coupling the sleeve 120 and the core 180 to the base 190 is not necessarily limited thereto.

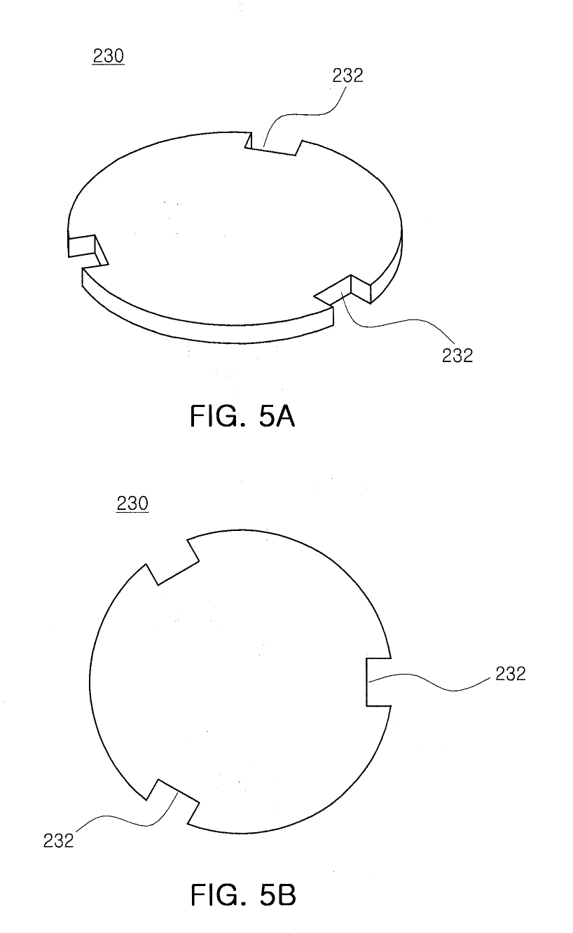

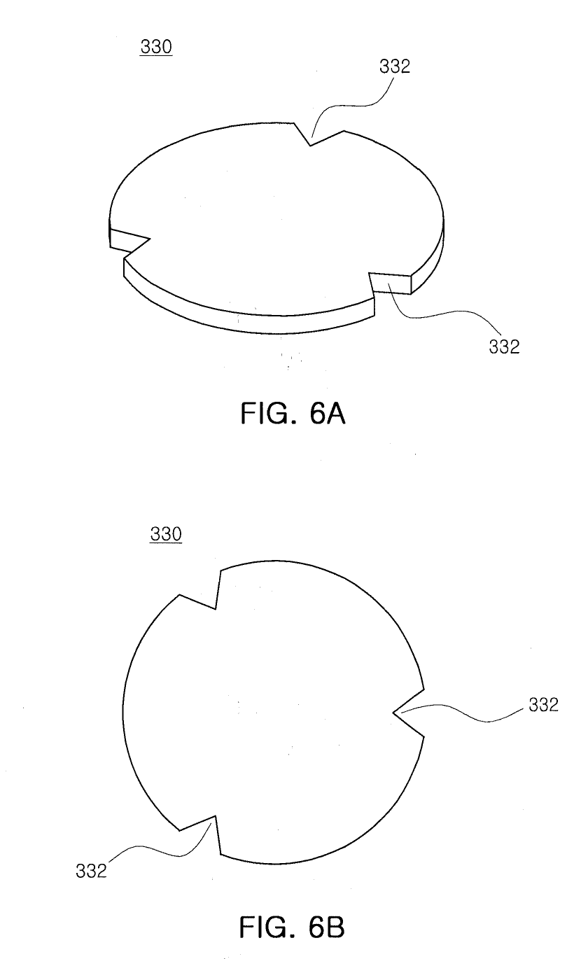

FIGS. 5A and 5B are a schematic cut-away perspective view and a schematic plan view showing a first modified example of the base cover provided in the bearing assembly according to the embodiment of the present invention. FIGS. 6A and 6B are a schematic cut-away perspective view and a schematic plan view showing a second modified example of the base cover provided in the bearing assembly according to the embodiment of the present invention.

FIGS. 5A and 5B are a schematic cut-away perspective view and a schematic plan view showing a first modified example of a base cover provided in the bearing assembly according to the embodiment of the present invention. FIGS. 6A and 6B are a schematic cut-away perspective view and a schematic plan view showing a second modified example of a base cover provided in the bearing assembly according to the embodiment of the present invention.

Referring to FIGS. 5A and 5B, a deformation prevention part 232 formed in a base cover 230 may allow upper and lower surfaces of the base cover 230 to be in communication with each other.

Here, a radial cross-section of the deformation prevention part 232 provided in the upper surface or the lower surface of the base cover 230 may have a quadrangular shape.

However, the radial cross-section of the deformation prevention part 232 is not limited to having the quadrangular shape as shown in FIGS. 5A and 5B, but may also be changed according to the intention of those skilled in the art.

Referring to FIGS. 6A and 6B, a radial cross section of a deformation prevention part 332 formed in an upper surface or a lower surface of a base cover 330 may have a triangular shape, that is, a wedge shape.

Therefore, since the stress due to the press-fitting may be significantly reduced by the deformation prevention part 332 and the deformation prevention space S formed by the deformation prevention part 332, the deformation of the base cover 330 after the press-fitting may be prevented.

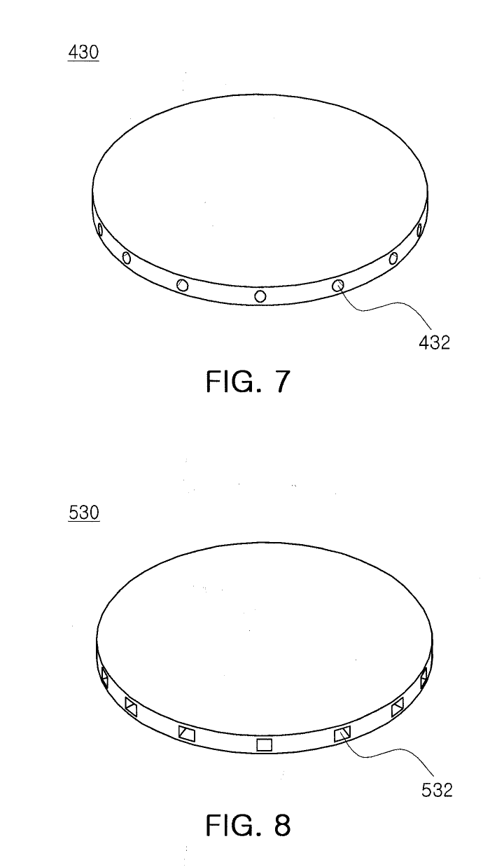

FIG. 7 is a schematic cut-away perspective view showing a third modified example of a base cover provided in the bearing assembly according to the embodiment of the present invention. FIG. 8 is a schematic cut-away perspective view showing a fourth modified example of a base cover provided in the bearing assembly according to the embodiment of the present invention.

Referring to FIG. 7, a base cover 430 may include a deformation prevention part 432 formed as a groove having a circular shape from an outer peripheral surface thereof in the inner diameter direction.

The deformation prevention part 432 may have a hemispheric shape and may not allow upper and lower surfaces of the base cover 430 to be in communication with each other, unlike the deformation prevention parts 132, 232, and 332 described with reference to FIGS. 1 through 6B.

However, similar to the deformation prevention parts 132, 232, and 332 described with reference to FIGS. 1 through 6B, the deformation prevention part 432 includes the deformation prevention space S formed between the deformation prevention part 432 and the protrusion part 126 of the sleeve 120 to significantly reduce the stress due to the press-fitting, whereby the deformation of the base cover 430 after the press-fitting may be prevented.

Referring to FIG. 8, a deformation prevention part 532 formed in a base cover 530 may be formed as a groove having a quadrangular shape from an outer peripheral surface thereof.

The deformation prevention part 532 may have a hexahedral shape or a quadrangular pyramid shape and includes the deformation prevention space S formed between the deformation prevention part 532 and the protrusion part 126 of the sleeve 120 to significantly reduce the stress due to press-fitting, whereby the deformation of the base cover 530 after the press-fitting; may be prevented.

As set forth above, with a bearing assembly and a motor including the same according to the embodiments of the present invention, coupling force between a base cover and asleeve may be improved and at the same time, a deformation amount of the base cover during a process of coupling the base cover and the sleeve may be reduced.

In addition, an adhesive is not used in coupling the base cover and the sleeve, whereby a defect such as non-rotation of the rotating member due to adhesive foreign materials may be prevented in advance.

While the present invention has been shown and described in connection with the embodiments, it will be apparent to those skilled in the art that modifications and variations can be made without departing from the spirit and scope of the invention as defined by the appended claims.

What is claimed is:

1. A bearing assembly comprising:
a sleeve supporting a shaft;
a base cover coupled to the sleeve by press-fitting and closing a lower portion of the sleeve; and
at least one deformation prevention part formed to be depressed from an outer peripheral surface of the base cover in an inner diameter direction and preventing deformation of the base cover when the base cover is press-fitted into the sleeve.

2. The bearing assembly of claim 1, wherein the sleeve includes a protrusion part formed by protruding an edge of the lower portion thereof in an axial direction, and
the protrusion part has an inner peripheral surface coupled to the outer peripheral surface of the base cover.

3. The bearing assembly of claim 1, wherein the sleeve includes a protrusion part formed by protruding an edge of the lower portion thereof in an axial direction, and the protrusion part and the deformation prevention part include a deformation preventing space formed therebetween, the deformation preventing space preventing the deformation of the base cover.

4. The bearing assembly of claim 1, wherein the base cover has an outer diameter larger than a diameter of an inner peripheral surface of the sleeve corresponding to the outer peripheral surface of the base cover.

5. The bearing assembly of claim 1, wherein the deformation prevention part allows upper and lower surfaces of the base cover to be in communication with each other.

6. The bearing assembly of claim 1, wherein the deformation prevention part is depressed in the inner diameter direction within a range in which a leakage of oil filling an upper portion of the base cover to the outside is blocked.

7. The bearing assembly of claim 1, wherein the at least one deformation prevention part includes a plurality of deformation prevention parts, the plurality of deformation prevention parts being symmetrical with regard to each other, based on a center of the shaft.

8. A motor comprising:
the bearing assembly of claim 1;
a hub rotating together with the shaft and including a magnet coupled thereto; and
a base including the sleeve and a core coupled thereto, the core having a coil wound therearound generating rotational driving force.
